(19) United States
(12) Patent Application Publication
(10) Pub. No.: US 2010/0264184 A1
(43) Pub. Date: Oct. 21, 2010

(54) Mounting device for bicycle accessories

(75) Inventor: Darren Retief, Vista, CA (US)

Correspondence Address: CHARLES E. BAXLEY, ESQUIRE, 90 JOHN STREET, SUITE 309, NEW YORK, NY, 10038, US

(73) Assignee: Ravx Inc.

(21) Appl. No.: 12/386,196

(22) Filed: Apr. 15, 2009

(51) Int. Cl. B62J 11/00

(52) U.S. Cl. 224/427

(57) ABSTRACT

A mounting device includes a carrier for attaching to a bicycle, a housing attached to the carrier and having a chamber formed between two side walls and a primary wall, and one or more gas bottles attached to the housing for partially blocking the lower portion of the chamber of the housing and for forming a lower support for the housing and for supporting various bicycle accessories in the chamber of the housing. The housing includes two mounting surfaces located between the side walls and the primary wall for attaching one or more bottle holders which are used for supporting water bottles.

### BACKGROUND OF THE INVENTION

1. Field of the Invention

The present invention relates to a mounting device, and more particularly to a mounting device for mounting or attaching to a bicycle and for easily supporting various bicycle accessories.

2. Description of the Prior Art

Typically, various bicycle accessories are required to be mounted or attached to a bicycle with various kinds of mounting devices, such as bags or brackets or receptacles.

For example, U.S. Pat. No. 4,643,343 to Goldman et al., U.S. Pat. No. 5,190,345 to Lin, and U.S. Pat. No. 5,127,563 to Chan et al. disclose three of the typical article carries or mounting devices for bicycle accessories and comprise a bag mounted or attached to the seat or other places of a bicycle with a support arm and a bracket, or with cloth straps for receiving or supporting or carrying various bicycle accessories, such as repair kits or the like.

However, the typical article carries or mounting devices or bags may only be used to receive the repair kits or the like, but may not be used to receive the gas bottles, the water bottles, or the other greater objects.

U.S. Pat. No. 5,833,188 to Studdiford et al. discloses another typical accessory mounting apparatus comprising a mounting base for engaging with the seat, the frame or the other places of a bicycle, and a fabric strap attached to the mounting base for mounting or attaching the mounting base to the bicycle, and for receiving or supporting or carrying various bicycle accessories, such as the repair kits, the water bottles, the bicycle pumps or the like.

However, the typical accessory mounting apparatus may only be used to receive or support or carry a single bicycle accessory, but may not be used to receive or support or carry the other objects or bicycle accessories.

The present invention has arisen to mitigate and/or obviate the afore-described disadvantages of the conventional mounting devices for bicycles.

### SUMMARY OF THE INVENTION

The primary objective of the present invention is to provide a mounting device for mounting or attaching to a bicycle and for easily supporting various bicycle accessories.

In accordance with one aspect of the invention, there is provided a mounting device for a bicycle comprising a carrier for attaching to the bicycle, a housing attached to the carrier, and including two side walls and a primary wall for forming a chamber between the side walls and the primary wall, and the housing including a lower portion, and at least one gas bottle attached to the lower portion of the housing for partially blocking the lower portion of the chamber of the housing and for forming a lower support for the housing, and for supporting various bicycle accessories in the chamber of the housing.

The gas bottle is attached to the lower portion of the primary wall of the housing. One or more further gas bottles may further be provided and attached to the primary wall of the housing and extended out of the chamber of the housing.

The carrier includes a bar secured to the carrier, and an anchor detachably attached to the bar for detachably mounting the carrier to the bicycle. The bicycle includes a seat having a seat rail, and the bar and the anchor are detachably attached to the seat rail of the seat.

The housing includes two mounting surfaces located between the side walls and the primary wall respectively, and at least one bottle holder is attached to either of the mounting surfaces of the housing.

The mounting surfaces of the housing are preferably inclined relative to the side walls and the primary wall of the housing respectively. The bottle holder includes two resilient arms for resiliently clamping and supporting a water bottle in the bottle holder.

The carrier includes an orifice formed therein for receiving a fastener, and the side walls of the housing each include a mounting ear secured to the carrier with the fastener.

The primary wall and/or the side walls of the housing each include at least one opening formed therein for weight reducing purposes. The housing includes an upper ear extended from the primary wall for engaging with a fastener.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a mounting device for a bicycle in accordance with the present invention;

FIG. 2 is an exploded view of the mounting device for the bicycle;

FIG. 3 is a perspective view of the mounting device for the bicycle;

FIGS. 4, 5 are perspective views similar to FIG. 3, illustrating the operation of the mounting device for the bicycle;

FIG. 6 is a partial side plan schematic view of the mounting device for the bicycle; and

FIG. 7 is another partial side plan schematic view similar to FIG. 6, illustrating the operation of the mounting device for the bicycle.

### DETAILED DESCRIPTION OF THE PREFERRED EMBODIMENT

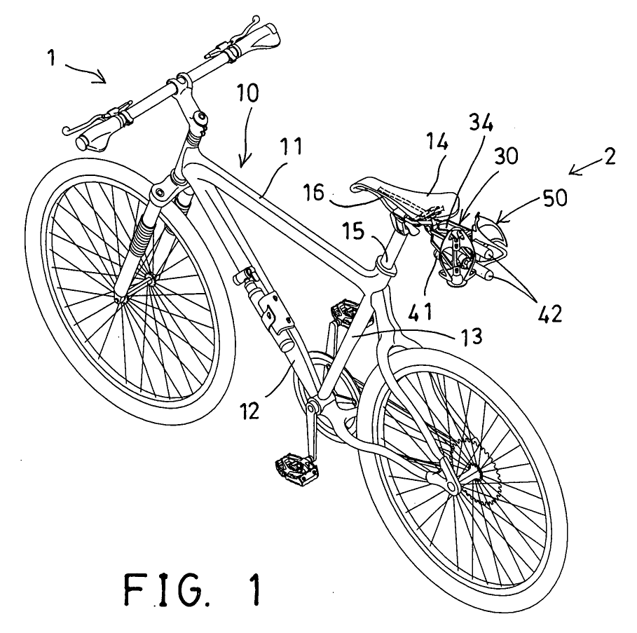

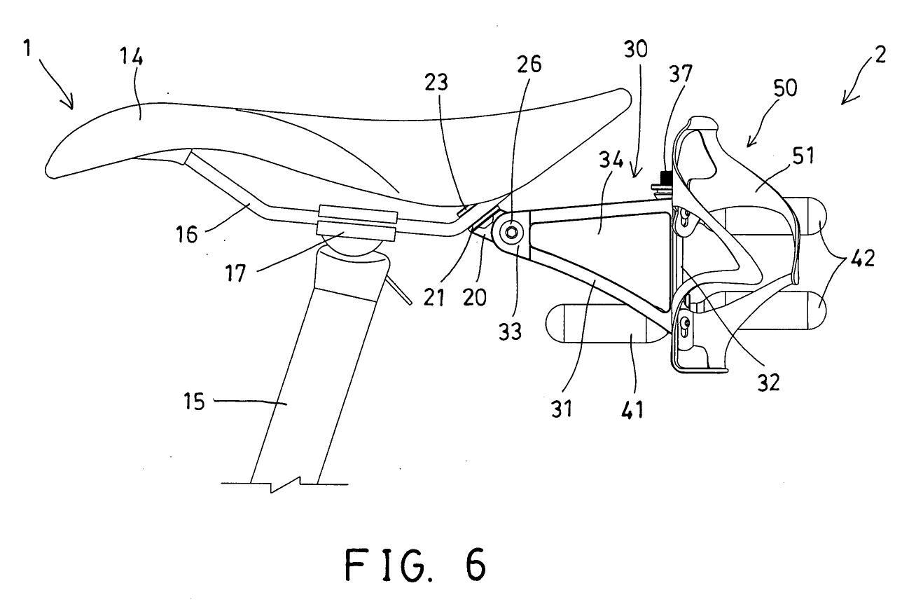

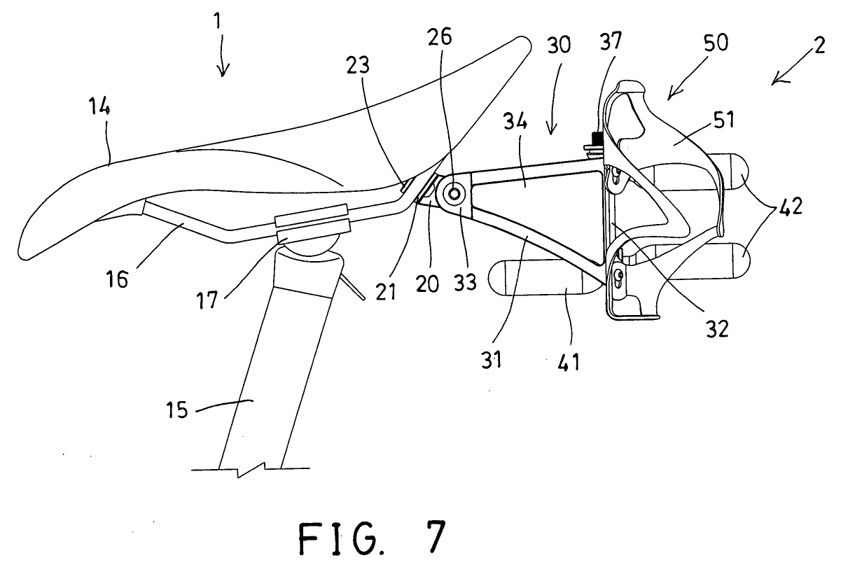

Referring to the drawings, and initially to FIGS. 1 and 6-7 a mounting device 2 in accordance with the present invention is provided for mounting or attaching to a bicycle 1, such as to a bicycle frame 10 or a seat 14 of the bicycle 1, in which the bicycle frame 10 of the bicycle 1 normally comprises a top tube 11, a down tube 12, and a seat tube 13, and a seat 14 slidably or adjustably mounted or attached to the seat tube 13 with a stem 15, and the seat 14 normally includes one or more saddle bridges or seat rails 16 for mounting or attaching to the stem 15 with a mounting bracket 17 and arranged for allowing the mounting bracket 17 and the saddle bridges or seat rails 16 and the seat 14 to be pivoted or tilted or adjusted relative to the stem 15 and the bicycle frame 10 to selected angular directions (FIGS. 6, 7).

The mounting device 2 comprises a carrier 20, a bar 21 fixed or secured to the carrier 20 with one or more fasteners 22, and an anchor 23 attached or secured to the bar 21 and/or the carrier 20 with one or more further fasteners 24 for engaging with the bicycle 1, such as engaging with the bicycle frame 10 or the saddle bridges or seat rails 16 of the seat 14, and for detachably mounting or securing the carrier 20 to the seat 14 or the bicycle frame 10 of the bicycle 1, the carrier 20 includes a lateral orifice 25 formed therein for receiving or engaging with a screw, bolt or fastener 26 which is engageable with a lock nut 27 for mounting or securing the other objects or bicycle accessories to the carrier 20.

The mounting device 2 further comprises a housing 30 including two side walls 31 having a rear portion formed or coupled or secured together with a rear or primary wall 32 for forming a chamber 39 within or between the side walls 31 and the primary wall 32 of the housing 30, and the side walls 31 each include a front end or mounting ear 33 arranged or disposed or engaged with the side portions of the carrier 20 and secured to the carrier 20 with the fastener 26 and the lock nut 27, and arranged for allowing the housing 30 to be pivoted or tilted or adjusted relative to the seat 14 or the bicycle frame 10 to selected angular directions (FIGS. 6, 7), particularly when the saddle bridges or seat rails 16 and the seat 14 are adjusted relative to the stem 15 and the bicycle frame 10 to different angular directions. The primary wall 32 and/or the side walls 31 each may further include one or more openings 34 formed therein for weight reducing purposes. It is preferable that the side walls 31 each include a tilted or inclined lower portion.

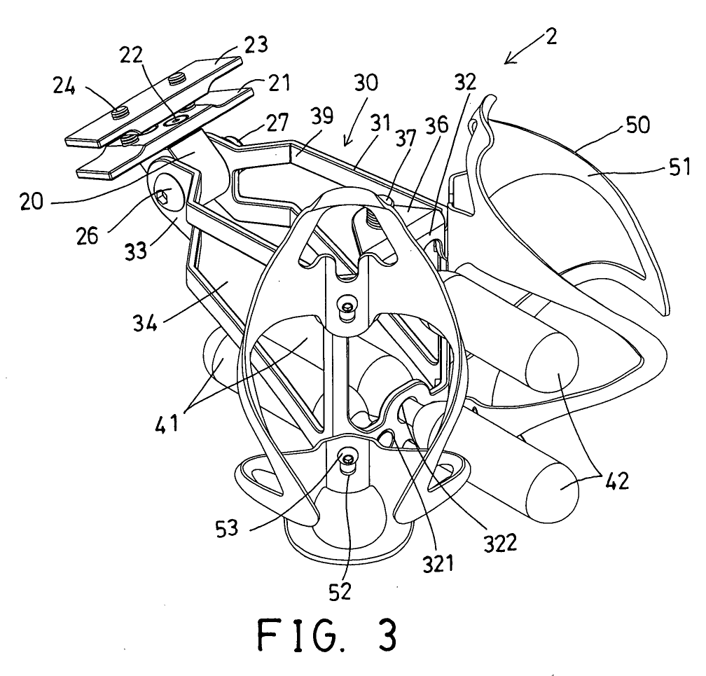

The housing 30 includes one or more (such as two) mounting surfaces 35 formed or coupled or located or disposed between the side walls 31 and the primary wall 32 respectively, and tilted or inclined relative to the side walls 31 and the primary wall 32 respectively, and the housing 30 includes an upper ear 36 extended from the primary wall 32 for engaging with a screw, bolt or fastener 37 which may be used to mount or attach various bicycle accessories to the housing 30. One or more (such as two) bottle holders 50 may be attached or secured to the housing 30, particularly to the mounting surfaces 35 of the housing 30 with one or more fasteners 53 and arranged to be tilted or inclined relative to the side walls 31 and the primary wall 32 respectively (FIGS. 3-5).

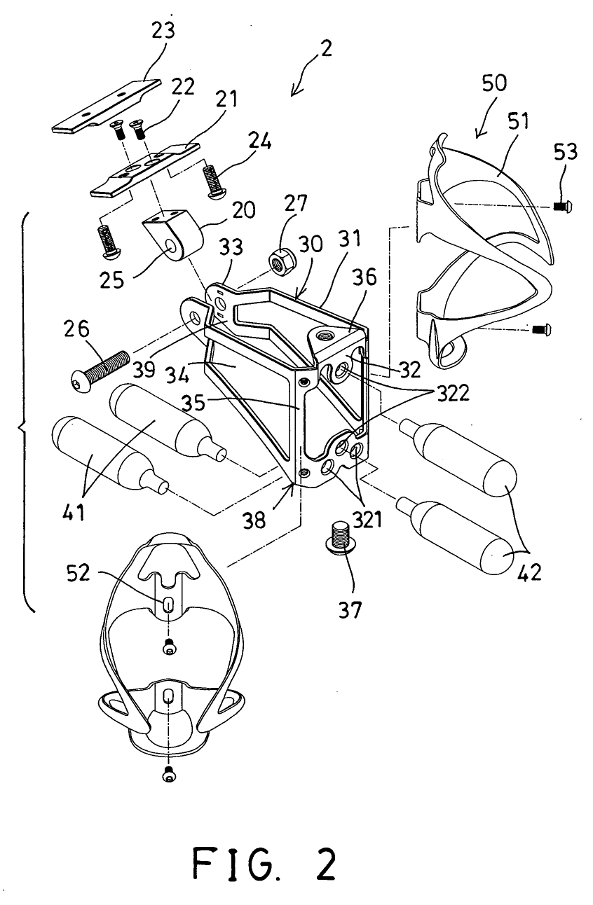

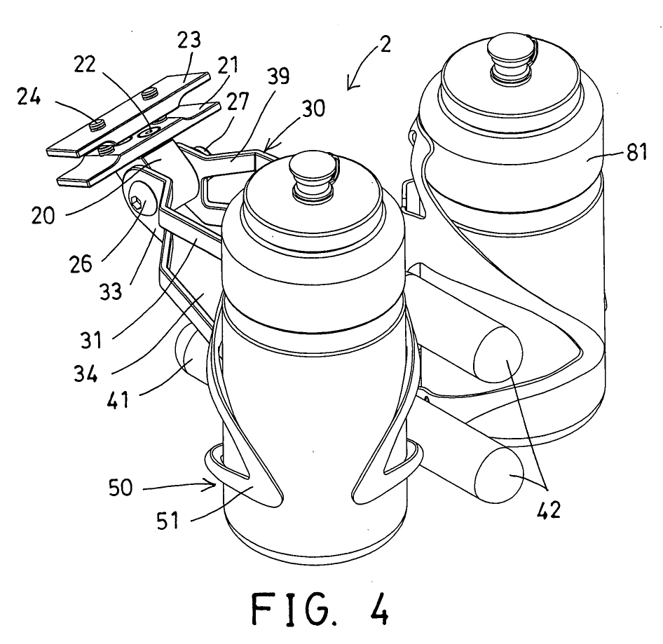

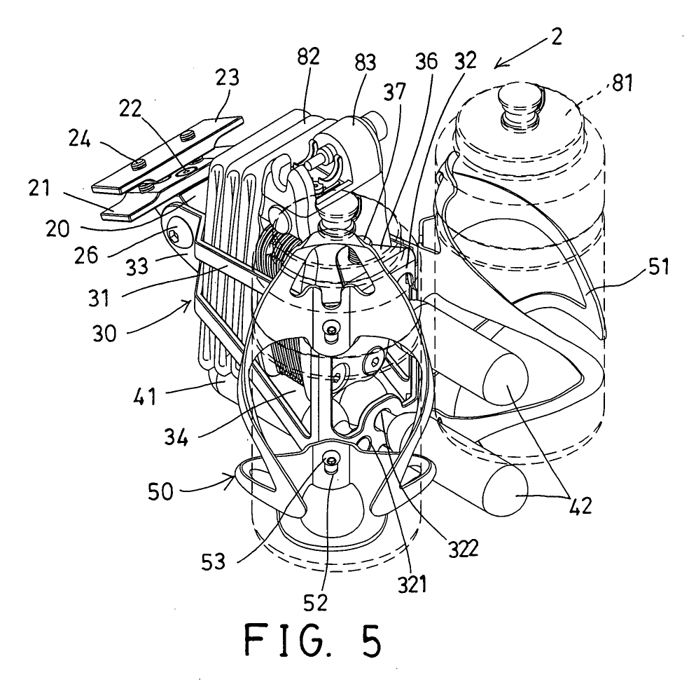

The bottle holders 50 each may include one or more (such as two) oblong holes 52 formed therein for slidably receiving the fasteners 53 and for allowing the bottle holders 50 to be moved or adjusted up and down relative to the housing 30, and each may include two resilient arms 51 for resiliently clamping and supporting the water bottles 81 in the bottle holders 50 (FIGS. 4, 5). The housing 30 further includes one or more (such as two) mounting apertures 321 formed in the bottom or lower portion 38 of the primary wall 32 or the housing 30 (FIG. 2) for mounting or attaching or securing one or more (such as two) gas bottles 41, such as the CO₂ bottles 41, and further includes one or more (such as two) mounting orifices 322 formed in the other portion of the primary wall 32 or the housing 30 for mounting or attaching or securing the other gas bottles or CO₂ bottles 42 which are disposed or extended out of the chamber 39 of the housing 30. The gas bottles or CO₂ bottles 41-42 may be provided for inflating the tires (not shown) of the bicycle 1. The tilted or inclined lower portion of the side walls 31 allows the gas bottles or CO₂ bottles 41 to be easily attached to or disengaged from the primary wall 32 of the housing 30.

As best shown in FIGS. 3 and 5, the gas bottles 41 are arranged or disposed or engaged in the bottom or lower portion 38 of the housing 30 for partially blocking the bottom or lower portion 38 of the chamber 39 of the housing 30, or for forming a bottom or lower wall or support for the housing 30, and arranged for allowing various bicycle accessories, such as tire repair straps 82, chain repair kits 83 or the like to be stably received and supported or carried or retained within the chamber 39 of the housing 30 (FIG. 5). The other gas bottles or CO₂ bottles 42 may be arranged or disposed or supported on the primary wall 32 and between the bottle holders 50 for allowing the mounting device 2 to carry or support various bicycle accessories, such as the gas bottles or CO₂ bottles 41-42, the bottle holders 50, the water bottles 81, the tire repair straps 82, the chain repair kits 83 or the like.

Accordingly, the mounting device in accordance with the present invention includes a structure for mounting or attaching to a bicycle and for easily supporting various bicycle accessories.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A mounting device for a bicycle comprising:
a carrier for attaching to said bicycle,
a housing attached to said carrier, and including two side walls and a primary wall for forming a chamber between said side walls and said primary wall, and said housing including a lower portion, and
at least one gas bottle attached to said lower portion of said housing for partially blocking said lower portion of said chamber of said housing and for forming a lower support for said housing, and for supporting various bicycle accessories in said chamber of said housing.

2. The mounting device as claimed in claim 1, wherein said at least one gas bottle is attached to said lower portion of said primary wall of said housing.

3. The mounting device as claimed in claim 1, wherein at least one second gas bottle is attached to said primary wall of said housing and extended out of said chamber of said housing.

4. The mounting device as claimed in claim 1, wherein said carrier includes a bar secured to said carrier, and an anchor detachably attached to said bar for detachably mounting said carrier to said bicycle.

5. The mounting device as claimed in claim 4, wherein said bicycle includes a seat having a seat rail, and said bar and said anchor are detachably attached to said seat rail of said seat.

6. The mounting device as claimed in claim 1, wherein said housing includes two mounting surfaces located between said side walls and said primary wall respectively, and at least one bottle holder is attached to either of said mounting surfaces of said housing.

7. The mounting device as claimed in claim 6, wherein said mounting surfaces of said housing are inclined relative to said side walls and said primary wall of said housing respectively.

8. The mounting device as claimed in claim 6, wherein said at least one bottle holder includes two resilient arms for resiliently clamping and supporting a water bottle in said at least one bottle holder.

9. The mounting device as claimed in claim 1, wherein said carrier includes an orifice formed therein for receiving a fastener, and said side walls of said housing each include a mounting ear secured to said carrier with said fastener.

10. The mounting device as claimed in claim 1, wherein said side walls of said housing each include at least one opening formed therein for weight reducing purposes.

11. The mounting device as claimed in claim 1, wherein said primary wall of said housing includes at least one opening formed therein for weight reducing purposes.

12. The mounting device as claimed in claim 1, wherein said housing includes an upper ear extended from said primary wall for engaging with a fastener.
